(19) United States
(12) Patent Application Publication
(10) Pub. No.: US 2007/0192257 A1
(43) Pub. Date: Aug. 16, 2007

(54) METHOD OF SUPPLYING ADMIXTURE FORMULATIONS FOR CONCRETE

(76) Inventors: Stephen L. Amey, Aurora, OH (US); Tate Coverdale, Chagrin Falls, OH (US); Joseph A. Daczko, Hiram, OH (US); Michael Kerns, Medina, OH (US); Anthony A. Schlagbaum, Chagrin Falls, OH (US)

Correspondence Address: BASF CORPORATION;Patent Department, 1609 BIDDLE AVENUE, MAIN BUILDING, WYANDOTTE, MI, 48192, US

(21) Appl. No.: 11/678,111

(22) Filed: Feb. 23, 2007

Related U.S. Application Data
(63) Continuation-in-part of application No. 11/202,813, filed on Aug. 12, 2005.
(60) Provisional application No. 60/603,224, filed on Aug. 20, 2004.

(51) Int. Cl. G06F 17/00

(52) U.S. Cl. 705/400

(57) ABSTRACT

A method for an admixture producer to provide admixture formulations to a concrete producer, including inputting technical information, wherein the technical information is inputted into the computer control system by the concrete producer, determining types and levels of admixture raw materials that are needed to attain the desired performance characteristics, dispensing the types and quantities of admixture raw materials needed to produce an admixture formulation having properties needed to attain the desired performance characteristics, wherein the admixture raw materials are dispensed from an inventory of admixture raw materials that is maintained in proximity to a concrete mixing facility of the concrete producer, and invoicing the concrete producer for the admixture formulation.

### CROSS REFERENCE TO RELATED APPLICATIONS

This application is a continuation in part of co-pending U.S. Ser. No. 11/202,813, filed Aug. 12, 2005, which claims the benefit of the filing date of U.S. Provisional Application for Patent Serial No. 60/603,224, filed Aug. 20, 2004, both of which applications are incorporated by reference herein as if fully written out below.

### BACKGROUND OF THE INVENTION

Concrete is used in a wide variety of applications in larger quantities than any other manmade material. For instance, concrete is used as pavement for highways, roads, driveways, walkways, airport runways, and parking lots. It is also commonly used in the walls, floors, and foundations of both large and small buildings. Concrete is also commonly used in dams, bridges, and countless other types of applications.

The basic constituents utilized in making concrete include cement, an aggregate, and water. The cement will typically be a mixture of various oxides of calcium, silicon, and aluminum which is made by heating limestone with clay and grinding that mixture, which is sometimes called clinker, with gypsum. The aggregate will normally be a mixture of sand, gravel, and/or crushed stone of varying particle size. For ecological reasons recycled aggregates from construction waste and the demolition of old masonry structures are coming into increasing levels of utilization in the world today.

In building concrete structures water is mixed into a mixture of the cement and aggregate. Then the wet concrete composition is poured into the desired position, frequently in a mold, for it to cure into a permanent shape. During this curing process the water chemically reacts with the cement through a hydration reaction wherein the cement hardens and ultimately acts to glue the aggregate together to create the desired hard concrete structure. Stronger concrete can be made by reducing the ratio of water to cement in the cement paste employed in making the concrete. For instance, high-strength concrete having a compressive strength of greater than 40 MPa is typically made by lowering the ratio of water to cement in the concrete composition to 0.35 or lower. However, as the ratio of water to cement is reduced the workability of the wet concrete composition becomes more difficult. In other words, wet concrete compositions that contain low amounts of water are more difficult to form into the desired shape in a mold or otherwise. Accordingly, high strength concrete compositions are typically formulated with plasticizers to compensate for the reduced workability that results from the low level of water utilized to attain the desired level of strength.

Admixtures are frequently added to concrete to provide it with desirable characteristics that are not obtainable with basic concrete mixtures or to modify properties of the concrete to make it more readily useable or more suitable for a particular purpose or for cost reduction. In the art of concrete formulation, an admixture can be any functional material or composition, other than hydraulic cement, aggregate or water that is used as a component of the concrete or mortar to enhance some characteristic thereof. For example, as described above, plasticizers can be added to the concrete to provide it with improved workability for ease of placement with reduced consolidating effort and in reinforced concretes that are required to flow uniformly without leaving void space under reinforcing bars.

Additional examples of admixtures used in concrete include accelerators, retarders, air-entrainers, foaming agents, water reducers, corrosion inhibitors, and pigments. Accelerators are used to increase the cure rate (hydration) of the concrete formulation and are of particular importance in applications where it is desirable for the concrete to harden quickly and in low temperature applications. Retarders act to slow the rate of hydration and increase the time available to pour the concrete and to form it into a desired shape. Retarders are of particular importance in applications where the concrete is being used in hot climates. Air-entrainers are used to distribute tiny air bubbles throughout the concrete. Air-entrainers are of particular value for utilization in regions that experience cold weather because the tiny entrained air bubbles help to allow for some contraction and expansion to protect the concrete from freeze-thaw damage. Pigments can also be added to concrete to provide it with desired color characteristics for aesthetic purposes.

Thus, the major reasons for using admixtures are (1) to achieve certain structural improvements in the resulting cured concrete; (2) to improve the quality of concrete through the successive stages of mixing, transporting, placing, and curing during adverse weather or traffic conditions; (3) to overcome certain emergencies during concreting operations; and (4) to reduce the cost of concrete construction. In some instances, the desired concrete performance characteristics can only be achieved by the use of an admixture. In some cases, using an admixture allows for the use of less expensive construction methods or designs, the savings from which can more than offset the cost of the admixture.

An admixture can typically be added to a batch of concrete at any point during the mixing procedure used in its preparation. In the concrete industry today, admixtures are routinely formulated by combining two or more functional ingredients into a single solution or dispersion for convenience of handling and ease of mixing. Determining the proper combination of functional ingredients used in making the admixture is sometimes a challenging task, particularly in cases where the various ingredients do not act independently of each other and in cases where they act in a synergistic manner. It should also be noted that the proper combination of admixture ingredients needed to attain optimal results is also dependent upon other variables, such as cement type, cement source, aggregate type, weather conditions, and the like. In any case, over the years persons skilled in the art of concrete admixture formulation have developed know-how and expertise in the art of mixing appropriate admixture ingredients at proper ratios to attain desired results.

The results attained utilizing a given admixture ingredient is frequently not a function of the level of the ingredient used. There is not necessarily a linear relationship between the amount of a given admixture component employed and the targeted performance characteristic attained. For example, dispersants and defoamers are commonly blended together in admixture formulations, in order for the defoamer to provide air control to compensate for the incidental air entraining performance of the dispersant in the cementitious mix. However, the amount of air control required is not linearly related to the amount of dispersant that needs to be added to provide the optimal water reducing function. For example, if a double dose of dispersant is required for a particular cementitious mix for water reduction, the double dose of defoamer that would be typically provided in a preformulated admixture would not compensate for the amount of air control actually needed. Traditional admixture dispensing techniques can accordingly only deliver specific target performance characteristics, rather than the continuous range of concrete performance objectives that are required to attain optimal results. Optimal concrete performance can frequently only be attained by utilizing an admixture that has been specifically formulated for the specific situation with the appropriate ingredients at proper levels.

Admixtures are commercially available as liquids, dispersions, and water-soluble solids or powders. Such admixtures can be added to cementitious mixtures as solids or ready-to-use liquids that are added at bulk blending stations, including ready-mix plants or pre-cast plants. The successful use of admixtures depends, of course, upon the accuracy with which they are prepared and batched. Batching means the weighing or volumetric measuring of the ingredients for a batch of either concrete or mortar and then introducing them into the mixer. The amount of admixture added during batching must be carefully controlled. Inaccuracies in the amount of admixture added can significantly affect the properties and performance of the concrete being batched and even defeat the original purpose for including the admixture. The need for accuracy in measuring the amount of admixture to be added to a batch is particularly acute where only a relatively small amount of admixture is required for the job.

Today, admixtures are typically made by a supplier with the admixtures being shipped to the concrete producer, typically a ready-mix company, as specific discrete compositions. Such admixtures are normally delivered to the concrete blending facilities in compartmentalized trucks with all of the admixtures being shipped and stored separately. An inventory of all the individual admixtures used by the concrete producer must accordingly be maintained at the concrete producer's facility until they are dispensed into concrete formulations. A typical concrete blending plant uses about 4 to about 6 admixture formulations. Large facilities maintain an inventory of up to about 8 admixture formulations. Separate storage tanks or silos are needed for each admixture that is maintained in inventory at the facility. This takes space, requires a capital investment for each individual storage container, and ties up working capital in additional inventory. For this reason, concrete producers typically limit the number of admixture formulations that they use. Additionally, the specific admixtures that are maintained in inventory are normally adjusted on a seasonal and/or project specific basis. Switching the contents of a storage container can lead to cross-contamination of formulations and potentially to unpredictable or non-uniform performance in the cementitious mix or mortar product.

It is therefore desirable to provide a method for the custom blending of admixture components at the mixing site in a manner that accurately provides desired performance characteristics to the cementitious mix or concrete or mortar product, while minimizing container space requirements.

Additional benefits associated with producing custom made admixture formulations on an as needed basis at the facility of the concrete producer where the concrete is being made or in close proximity to the concrete producer's facility include optimized admixture performance, better inventory control, on-demand supply, reduced overall cost, and in some cases elimination of the need for admixture stabilizers. However, such admixture formulation supply systems cannot be implemented using standard methods of inventory control, pricing, invoicing, and system maintenance. The concrete producer is provided with an admixture formulation that is custom made to optimize performance for use in making the needed concrete.

Additionally, there is clearly a need for developing a pricing strategy under which the admixture supplier is willing to sell the custom made admixture formulation and under which the concrete producer is willing purchase it, without need for recurring price negotiations.

### SUMMARY OF THE INVENTION

The present invention relates to a method for making admixture formulations that are custom blended at the facility of a concrete producer to attain desired performance characteristics while utilizing various concrete types and aggregate types. The admixture formulation dispensed at the cement manufacturing facility can also be custom made by taking process variables, such as ambient temperature, air content, and the water to cement ratio into account. In making such admixture formulations various admixture raw materials are utilized at levels that are adjusted as need in to meet the requirements desired at the time to attain specified performance characteristics. Since known admixture formulations of previously specified compositions are not necessarily dispensed, standard pricing and billing methods cannot be implemented. Accordingly, the method of this invention calls for pricing which is based upon the functional characteristics of the admixture formulation. More specifically, the admixture formulation is invoiced at a price that corresponds to the type of function that it generally provides, such as a water reducer, accelerator, retarder, air-entrainer, or viscosity modifier. Also, in the practice of this invention the admixture raw materials are maintained under the ownership of the admixture producer with the ownership of the admixture formulation passing to the concrete producer at the time that it is made and simultaneously dispensed. This invention eliminates the need for the admixture producer or the concrete producer to maintain any inventory of admixture formulations and provides a system of just-in-time inventory management.

The present invention more specifically discloses a method for an admixture producer to provide admixture formulations to a concrete producer, said method comprising: (1) inputting technical information including at least one member selected from the group consisting of desired performance characteristic, a mix design, or a mix design code into a computer control system, wherein the technical information is inputted into the computer control system by the concrete producer, (2) determining types and levels of admixture raw materials that are needed to attain the desired performance characteristics, (3) dispensing the types and quantities of admixture raw materials needed to produce an admixture formulation having the properties needed to attain the desired performance characteristics, wherein the admixture raw materials are dispensed from an inventory of admixture raw materials that is maintained in proximity to a concrete mixing facility of the concrete producer, and (4) invoicing the concrete producer for the admixture formulation, wherein said invoice includes a charge for the admixture formulation dispensed. The charge is based upon the volume of admixture formulation dispensed multiplied by a base price. The base price is selected from a group of base prices, where the base prices are determined according to functional characteristics of the admixture formulation, and wherein the base prices have been previously agreed upon by the admixture producer and the concrete producer.

Alternatively, in step (4), the invoice charge for the admixture formulation is based on a charge for the volume of admixture raw materials dispensed multiplied by a base price, where the base price is selected from base prices that have been previously agreed upon by the admixture producer and the concrete producer.

The present invention further provides a method for an admixture producer to service the needs of concrete producers in making concrete having desired concrete performance characteristics. Said method comprises the same steps (1)-(3) as described above. Step four of the method is invoicing the concrete producer for the services provided, where the invoice includes a charge based on the volume of concrete produced multiplied by a base price. The base price is selected from a group of base prices where said base prices are determined according to concrete performance characteristics of the concrete produced and said base prices have been previously agreed upon by the admixture producer and the concrete producer.

### DETAILED DESCRIPTION OF THE INVENTION

The method of this invention can be of benefit to any entity that produces concrete, such as ready-mix companies, and can also provide advantages for admixture producers. It is of particular benefit to concrete producers that make specialty concrete formulations that are designed for specific applications. In any case, the subject invention is applicable to systems that are capable of delivering custom made admixture formulations to concrete producers on a batch by batch basis according to specific technical requirements needed in a specific batch. In practicing the subject invention it is, of course, possible to make multiple batches having the same composition utilizing the same admixture formulation or the admixture formulation can be changed from one batch to another. United States Patent Application Publication No. 2006/0039233 A1 describes a technique for the custom preparation of admixture formulations that can be used in the practice of this invention. The teachings of United States Patent Application Publication No. 2006/0039233 A1 are accordingly incorporated herein by reference.

In the first step of the method of this invention technical information relating to a batch of concrete being made is inputted into a computer control system. This technical information includes at least one desired performance characteristic, a mix design, or a mix design code. The performance characteristics that can be inputted into the computer control system include desired attributes for the concrete that will be mixed and can include, but are not limited to, flexural strength, compressive strength, slump, setting time, and finishability characteristics. In some cases it may be desirable for the concrete producer to input a specific mix design or a mix design code that are known to possess the needed performance characteristics for a specific batch of concrete. The specific mix design or mix design code will, of course, facilitate production of a concrete composition having the required performance characteristics. The product design or product design code will result in one or more desired performance characteristics in the end concrete composition. The mix design can also include information that specifies the type and/or quantity of one or more ingredients used in making the specific concrete formulation, such as the cement type, aggregate type, origin of the cement, origin of the aggregate, composition of the cement, composition of the aggregate, identify of impurities, quantities of ingredients, ratios of ingredients, and the like. Mix design codes will typically be a code that provides for a known mix design and are used to simplify and expedite the specification of a desired mix design. The mix design code can be any term that identifies the mix design and will typically be a number, letter, symbol, code word, or combination of numbers, letters, symbols and/or words.

The technical information that is inputted into the computer can also include one or more material variables and one or more process variables. For instance, the material variables inputted can be an indication of the cement type, the aggregate type, aggregate size, the source or origin of the cement, the source or origin of the aggregate, impurity identification, qualitative and quantitative cement compositional information, and qualitative and quantitative aggregate compositional information. Some representative examples of process variables include ambient temperature, air content, and water to cement ratios. These items of technical information can be manually entered into the computer or can be automatically inputted. For example, the ambient temperature can be automatically inputted by integrating a thermocouple or infrared temperature detection device into the system so as to directly input the ambient temperature at the location of the cement mixing facility into the computer. It some cases it is advantageous to input predicted temperatures from weather forecasts for the local area and estimated time that the concrete will be poured. In any case, some of the technical information entered into the computer system can be automatically generated.

After the technical information has been entered, the types and quantities of admixture raw materials required to achieve the desired performance characteristics for the batch of concrete being made are determined. In a preferred embodiment of this invention, the computer calculates the types and levels of admixture raw materials that are needed to attain the desired performance characteristics for the concrete batch being made. This calculation is preferably done automatically after all of the technical information has been inputted. In other words, the computer calculates the types and levels of admixture raw materials that are needed to attain the specified performance characteristics. For example, the computer generated admixture formulation can call for admixture raw materials including air entrainers, defoamers, water reducers, accelerators, retarders, pigments, corrosion inhibitors, and the like in specified quantities.

After the computer calculates the specific admixture raw materials and the quantity thereof needed to produce an admixture formulation having the properties needed to attain the desired performance characteristics the admixture formulation is dispensed to the concrete manufacturer. This dispensing of the admixture can be done immediately after making the calculation or on a delayed basis. For example, the admixture made can be dispensed immediately into a batch of base concrete or it can be dispensed at a subsequent time. It should also be noted that the admixture can be dispensed directly into a batch of concrete, such as directly into a concrete mixer, or it can be dispensed into a holding vessel or silo for subsequent utilization. It should also be noted that the admixture can be dispensed as a homogeneous blend of the admixture raw materials or as separate streams of the admixture raw materials. In other words, the admixture raw materials can be introduced into the base concrete composition as a blend or separately.

An additional benefit associated with utilizing the method of this invention is that some admixture components can be eliminated from the formulation entirely by virtue of the fact that the admixture formulation is made on a just-in-time basis. More specifically, certain admixture components that would ordinarily be needed for long term storage stability can be precluded from the formulation. This is particularly the case in admixture formulations that include incompatible constituents, such as defoamers and polycarboxylates, which would ordinarily require a surfactant for a satisfactory level of shelf life.

The admixture raw materials are maintained for subsequent use in making admixtures within close proximity to the mixing facility of the concrete producer so that it will be convenient and cost effective to repeatedly transport the custom made admixture formulations to the facility for each new batch of concrete being made. In most cases the admixture raw materials will be held in inventory at the facility of the concrete manufacturer or on an adjacent parcel of property. This is in contrast to conventional commercial admixture supply methods where the admixture raw materials are pre-formulated at the facility of the admixture supplier and shipped to the concrete producer as finished product. Conventionally, the concrete producer was supplied with a finite set of admixture formulations and charged on a per unit volume basis.

In the present invention it is preferred for the admixture raw materials to be both maintained and dispensed in admixture formulations at the facility of the concrete manufacturer. In most cases it is most preferred for the admixtures to be dispensed directly into base concretes at the facility of the concrete manufacturer. The admixture raw materials are maintained under the ownership of the admixture producer even though they may be stored in inventory at the facility of the concrete manufacturer.

Implementing the method of this invention provides “just-in-time” inventory control. This is because the admixture needed to attain desired concrete performance characteristics is not made until shortly before it is needed in making a batch of concrete. Accordingly, the concrete producer is not required to maintain a substantial inventory of admixtures and may not maintain any inventory of admixtures. The admixture formulation made can be immediately dispensed into the base concrete. In any case, the admixture formulation will typically be maintained in the concrete producers inventory for a period of less than 60 minutes, preferably less than 40 minutes, and most preferably less than 20 minutes. This is advantageous because the concrete producer does not need to devote its working capital to maintain an inventory of admixtures. Additionally, the concrete producer is not exposed to risks of casualty loss of admixture inventory.

Ownership of the admixture dispensed to the concrete producer and the associated risk of casualty loss will normally pass from the admixture supplier to the concrete producer at the time that it is dispensed. In many cases the concrete producer will own the admixture from the moment it is created by mixing admixture raw materials. However, the identity of the exact chemical composition of the admixture will typically not be revealed to the concrete manufacturer. The specifics of the chemical composition of the admixture formulation are typically confidential and proprietary information that is owned by and remains under the ownership of the admixture supplier. Such information may include, but is not limited to, the chemical identity of one or more admixture components, amounts of such admixture components, and ratios of the admixture components utilized in making the admixture composition.

In one embodiment of this invention the concrete producer will be invoiced for the admixture formulation based upon the volume dispensed. In this case, the price charged to the concrete producer will be the quantity of admixture formulation dispensed multiplied by a base price. The base price will be previously agreed upon by the admixture producer and the concrete producer. Thus, the base price will be selected from a group of base prices that have been previously negotiated or otherwise agreed upon. In any case, the base prices will be based upon the basic functional characteristics of the admixture formulation. For example, the admixture formulation can be classified and priced as a water reducer, mid-range water reducer, high-range water reducer, accelerator, retarder, ARC (air refinement chemistry agent), air-entrainer, defoamer, rheology modifier, or viscosity modifier. The base price will not typically be based upon the quantity of any individual admixture raw material or combination of admixture raw materials employed in making the admixture formulation. Thus, in this embodiment of the invention, the unit price charged for the admixture is based solely upon the functional characteristics of the admixture formulation.

In another embodiment of this invention the concrete producer is invoiced for the admixture formulation on the basis of the volume of concrete produced multiplied by a base price. In this case, the base price is selected from a group of base prices wherein the base prices are predicated upon the concrete performance characteristics of the concrete produced. These concrete performance characteristics will typically be plastic performance characteristics or hardened characteristics. Some representative examples of plastic performance characteristics include, but are not limited to, workability level, workability retention, time of set, Theological properties, washout resistance, and the like. Some representative examples of hardened characteristics include, but are not limited to, air content and quality, ultimate strength, rate of strength development, freeze-thaw durability, shrinkage, creep potential, permeability, crack resistance, modulus of elasticity, alkali-silica reactivity, corrosion resistance, resistance to chemical and sulfate attack, color, ductility and the like. In any case, the base price charged for treating a given volume of concrete to attain the desired performance characteristics will be previously agreed upon by the admixture producer and the concrete producer. This charge per unit volume of treated concrete will represent the charge for the admixture dispensed as well as the charge for the service provided in helping the concrete producer to attain the desired concrete performance characteristics.

In still another embodiment of this invention the concrete producer is invoiced on a basis that includes a charge predicated on the volume of admixture components dispensed to the concrete producer. This charge is based upon the volume of admixture components dispensed times a base price per unit volume for the admixture component. The base price of the admixture components will be previously agreed upon by the admixture producer and the concrete supplier. The admixture components included in calculating the total amount that the concrete producer is invoiced may be individual admixture raw materials or, in the alternative, can be a mixture of two or more admixture raw materials. In cases where the admixture component includes more than one admixture raw material the individual admixture raw materials can be included to accomplish a single or multiple functional characteristics. Accordingly, the individual admixture raw materials included in the admixture component could be included to accomplish a single functional characteristic such as cure acceleration, cure retardation, air entrainment, and the like. On the other hand, the individual admixture raw materials included in the admixture component could be included to accomplish multiple objectives, such as water reduction in combination with air entrainment.

The concrete producer will normally be invoiced by the admixture supplier on a recurring basis for the quantity of admixture dispensed or the service provided in helping the concrete producer to manufacture concrete having desired performance characteristics. For instance, the admixture supplier will typically bill the concrete producer for the admixture supplied or the service provided over a convenient unit of time, such as one week periods, two week periods, or on a monthly basis. The terms for payment can be virtually any terms that are mutually agreeable to the admixture supplier and the concrete producer, for example net 30 days.

This invention is illustrated by the following illustrative examples that are for the purpose of illustration and are not to be regarded as limiting the scope of the invention or the manner in which it can be practiced.

### EXAMPLE 1

In the practice of this invention an admixture supplier can maintain a supply of various admixture raw materials in storage vessels at the facility of a concrete producer. The admixture raw materials remain under the ownership of the admixture producer even though they are at the facility of the concrete producer. Accordingly, the admixture supplier bears the risk of loss of the admixture raw materials due to theft, fire, explosion, and various acts of God. The storage tanks and dispensing equipment are also owned and maintained by the admixture producer. Accordingly, the admixture producer also bears the responsibility and expense of maintaining the storage vessels and dispensing equipment. Additionally, the admixture producer bears the risk of loss of admixture raw materials through leakage, product degradation and contamination.

In producing concrete the concrete producer can input desired performance characteristics. This is done by inputting a mix design code which specifies the relative amounts of cement, aggregate, water and admixture ingredients, to achieve specified performance characteristics. A computer control system is used to automatically calculate the levels and types of admixture raw materials that are needed to produce an admixture formulation that can be added to the base concrete to attain the desired performance characteristics such as compressive and flexural strength, set times, and air contents. The customer specifies the performance targets that the concrete must meet and the concrete producer formulates the concrete to meet the targets.

The admixture formulation is made by dispensing the needed types and volumes of the appropriate admixture raw materials to produce the needed admixture. The admixture that is made will then be dispensed into the base concrete formulation to obtain the desired performance characteristics. The concrete producer is subsequently invoiced based upon the volume of admixture formulation dispensed multiplied by a base price that has been previously agreed upon for admixture formulations having the basic functional characteristics of the admixture formulation dispensed.

### EXAMPLE 2

The steps are followed as set forth above, except the admixture is made by dispensing the admixture raw materials directly into the concrete to produce the admixture in-situ within the concrete. The invoice is then based upon the volume of admixture raw materials dispensed multiplied by a base price previously agreed upon for the admixture between the admixture producer and the concrete producer.

### EXAMPLE 3

The steps are followed as in Example 2 except that the invoice price is charged based on the quantity (volume) of at least two admixture components dispensed as the admixture multiplied by base price as previously agreed upon between the admixture producer and the concrete producer.

While certain representative embodiments and details have been shown for the purpose of illustrating the subject invention, it will be apparent to those skilled in this art that various changes and modifications can be made therein without departing from the scope of the subject invention.

What is claimed is:

1. A method for an admixture producer to provide admixtures to a concrete producer, said method comprising: (1) inputting technical information including at least one member selected from the group consisting of desired performance characteristic, a mix design, or a mix design code into a computer control system, wherein the technical information is inputted into the computer control system by the concrete producer, (2) determining types and levels of admixture raw materials that are needed to attain the desired performance characteristics, (3) dispensing the types and quantities of admixture raw materials needed to produce an admixture having the properties needed to attain the desired performance characteristics, wherein the admixture raw materials are dispensed from an inventory of admixture raw materials that is maintained in proximity to a concrete mixing facility of the concrete producer, and (4) invoicing the concrete producer for a charge for the admixture wherein the charge is based on one of (i) the volume of admixture formulation dispensed multiplied by a base price, (ii) the volume of at least two of the admixture raw materials dispensed multiplied by a base price wherein the base price is the base price of the raw materials and has been previously agreed upon by the admixture producer and the concrete producer.

2. The method of claim 1 wherein the invoice includes a charge for the admixture dispensed, wherein the charge is based upon the volume of admixture dispensed multiplied by a base price, wherein the base price is selected from a group of base prices, where said base prices are determined according to functional characteristics of the admixture formulation, and wherein the base prices have been previously agreed upon by the admixture producer and the concrete producer.

3. A method as specified in claim 1 wherein the basic functional characteristics of the admixture are selected from the group consisting of water reducers, mid-range water reducers, high-range water reducers, accelerators, retarders, air-entrainers, defoamers, rheology modifiers, and viscosity modifiers.

4. A method as specified in claim 1 wherein the base price is the previously agreed upon price for at least one of water reducers, mid range water reducers and high range water reducers.

5. A method as specified in claim 1 wherein the base price is the previously agreed upon price for accelerators.

6. A method as specified in claim 1 wherein the base price is the previously agreed upon price for retarders.

7. A method as specified in claim 1 wherein the base price is the previously agreed upon price for air-entrainers.

8. A method as specified in claim 1 wherein the base price is the previously agreed upon price for viscosity modifiers.

9. A method as specified in claim 1 wherein the inventory of admixture raw materials is maintained at the concrete mixing facility of the concrete producer.

10. A method as specified in claim 1 wherein the inventory of admixture raw materials is maintained under the ownership of the admixture producer and wherein the ownership of the admixture passes to the concrete producer at the time that it is dispensed to the concrete producer.

11. A method as specified in claim 1 wherein the admixture is mixed into a base concrete by the concrete producer to produce a cementitious composition having the desired performance characteristics.

12. A method as specified in claim 1 wherein cement type is inputted as a material variable.

13. A method as specified in claim 1 wherein temperature is inputted as a process variable.

14. A method as specified in claim 1 wherein at least one performance characteristic is selected from the group consisting of flexural strength, compressive strength, slump, setting time, and finishability.

15. A method as specified in claim 1 wherein the technical information further comprises at least one material variable.

16. A method as specified in claim 1 wherein the technical information further comprises at least one process variable.

17. A method as specified in claim 1 wherein the admixture raw materials include an air entrainer.

18. A method as specified in claim 1 wherein the admixture raw materials include a defoamer.

19. A method as specified in claim 1 wherein the admixture raw materials include a water reducer.

20. A method as specified in claim 1 wherein the admixture raw materials include a retarder.

21. A method as specified in claim 1 wherein the admixture raw materials include an accelerator.

22. A method as specified in claim 1 wherein cement origin is inputted as a material variable.

23. A method as specified in claim 1 wherein aggregate size is inputted as a material variable.

24. A method as specified in claim 1 wherein aggregate origin is inputted as a material variable.

25. A method as specified in claim 15 wherein at least one material variable is selected from the group consisting of cement type and aggregate type.

26. A method as specified in claim 16 wherein at least one process variable is selected from the group consisting of ambient temperature, air content, and water to cement ratio.

27. A method as specified in claim 1 wherein the calculation of the types and levels of admixture raw materials needed to attain the desired performance characteristics is adjusted at least in part on the basis of product feedback information.

28. A method for an admixture producer to service the needs of concrete producers in producing concrete having desired concrete performance characteristics, said method comprising: (1) inputting technical information including at least one member selected from the group consisting of desired performance characteristics, a mix design, or a mix design code into a computer control system, wherein the technical information is inputted into the computer control system by the concrete producer, (2) determining types and levels of admixture raw materials that are needed to attain the desired concrete performance characteristics, (3) dispensing the types and quantities of admixture raw materials needed to produce an admixture having the properties needed to attain the desired concrete performance characteristics, wherein the admixture raw materials are dispensed from an inventory of admixture raw materials that is maintained in proximity to a concrete mixing facility of the concrete producer, and (4) invoicing the concrete producer for the service provided, wherein the invoice includes a charge based on the volume of the concrete produced times a base price, wherein the base price is selected from a group of base prices, wherein the base prices are based upon the concrete performance characteristics of the concrete produced, and wherein the base prices have been previously agreed upon by the admixture producer and the concrete producer.

29. A method as specified in claim 28 wherein the concrete performance characteristics are selected from the group consisting of plastic characteristics and hardened characteristics.

30. A method as specified in claim 29 wherein the plastic characteristics are selected from the group consisting of workability level, workability retention, time of set, rheological properties, and washout resistance.

31. A method as specified in claim 29 wherein the hardened characteristics are selected from the group consisting of air content and quality, ultimate strength, rate of strength development, freeze-thaw durability, shrinkage, creep potential, permeability, crack resistance, modulus of elasticity, alkali-silica reactivity, corrosion resistance, resistance to chemical and sulfate attack, color, and ductility.

32. A method as specified in claim 29 wherein the plastic characteristics include workability level.

33. A method as specified in claim 29 wherein the plastic characteristics include workability retention.

34. A method as specified in claim 29 wherein the plastic characteristics include time of set.

35. A method as specified in claim 29 wherein the plastic characteristics include Theological properties.

36. A method as specified in claim 29 wherein the plastic characteristics include washout resistance.

37. A method as specified in claim 29 wherein the hardened characteristics include air content and quality.

38. A method as specified in claim 29 wherein the hardened characteristics include ultimate strength.

39. A method as specified in claim 29 wherein the hardened characteristics include rate of strength development.

40. A method as specified in claim 29 wherein the hardened characteristics include freeze-thaw durability.

41. A method as specified in claim 29 wherein the hardened characteristics include shrinkage.

42. A method as specified in claim 29 wherein the hardened characteristics include creep potential.

43. A method as specified in claim 29 wherein the hardened characteristics include permeability.

44. A method as specified in claim 29 wherein the hardened characteristics include crack resistance.

45. A method as specified in claim 29 wherein the hardened characteristics include modulus of elasticity.

46. A method as specified in claim 29 wherein the hardened characteristics include alkali-silica reactivity.

47. A method as specified in claim 29 wherein the hardened characteristics include corrosion resistance.

48. A method as specified in claim 29 wherein the hardened characteristics include resistance to chemical and sulfate attack.

49. A method as specified in claim 29 wherein the hardened characteristics include ductility.

50. A method as specified in claim 28 wherein the inventory of admixture raw materials is maintained at the concrete mixing facility of the concrete producer.

51. A method as specified in claim 28 wherein the inventory of admixture raw materials is maintained under the ownership of the admixture producer and wherein the ownership of the admixture passes to the concrete producer at the time that it is dispensed to the concrete producer.

52. A method as specified in claim 28 wherein the admixture is mixed into a base concrete by the concrete producer to produce a cementitious composition having the desired performance characteristics.

53. A method as specified in claim 28 wherein the calculation of the types and levels of admixture raw materials needed to attain the desired performance characteristics is adjusted at least in part on the basis of product feedback information.

54. A method for an admixture producer to provide admixtures to a concrete producer, said method comprising: (1) inputting technical information including at least one member selected from the group consisting of desired performance characteristic, a mix design, or a mix design code into a computer control system, wherein the technical information is inputted into the computer control system by the concrete producer, (2) determining types and levels of admixture raw materials that are needed to attain the desired performance characteristics, (3) dispensing the types and quantities of admixture raw materials needed to produce an admixture having the properties needed to attain the desired performance characteristics, wherein the admixture raw materials are dispensed from an inventory of admixture raw materials that is maintained in proximity to a concrete mixing facility of the concrete producer, and (4) invoicing the concrete producer for the admixture, wherein the invoice includes a charge based on the quantity of at least two admixture components dispensed as the admixture, wherein the charge is based upon the volume of admixture components dispensed multiplied by a base price, wherein the base price is selected from a group of base prices for said admixture components, and wherein the base prices have been previously agreed upon by the admixture producer and the concrete producer.

55. A method as specified in claim 1 wherein the invoice further includes an adjustment based upon quantities of admixture raw materials dispensed.

56. A method as specified in claim 28 wherein the invoice further includes an adjustment based upon quantities of admixture raw materials dispensed.

57. A method as specified in claim 54 wherein the inventory of admixture raw materials is maintained at the concrete mixing facility of the concrete producer.

58. A method as specified in claim 54 wherein the inventory of admixture raw materials is maintained under the ownership of the admixture producer and wherein the ownership of the admixture passes to the concrete producer at the time that it is dispensed to the concrete producer.

59. A method as specified in claim 54 wherein the admixture is mixed into a base concrete by the concrete producer to produce a cementitious composition having the desired performance characteristics.

60. A method as specified in claim 54 wherein the calculation of the types and levels of admixture raw materials needed to attain the desired performance characteristics is adjusted at least in part on the basis of product feedback information.
